(19) United States
(12) Patent Application Publication
(10) Pub. No.: US 2010/0236373 A1
(43) Pub. Date: Sep. 23, 2010

(54) Clamping Ball End for Musical Strings

(76) Inventor: Garry Goodman, Los Angeles, CA (US)

Correspondence Address: Garry Goodman, 1015 Gayley ave. #592, Los Angeles, CA, 90024, US

(21) Appl. No.: 12/206,650

(22) Filed: Sep. 8, 2008

Related U.S. Application Data
(60) Provisional application No. 60/973,606, filed on Sep. 19, 2007.

(51) Int. Cl. F16B 2/02

(52) U.S. Cl. 84/297 R

(57) ABSTRACT

This invention relates to a ball-ender apparatus for securing to a pre-selected length wire by passing through the apparatus and being secured by a precision screw from which the wire receives medial pressure locking the wire in place. Without an expensive winding machine or winding of wire or even modifications made to musical instruments, wire can be tensioned, after the precision screw is screwed onto the wire within the clamping ball end housing to securely hold the wire in place.

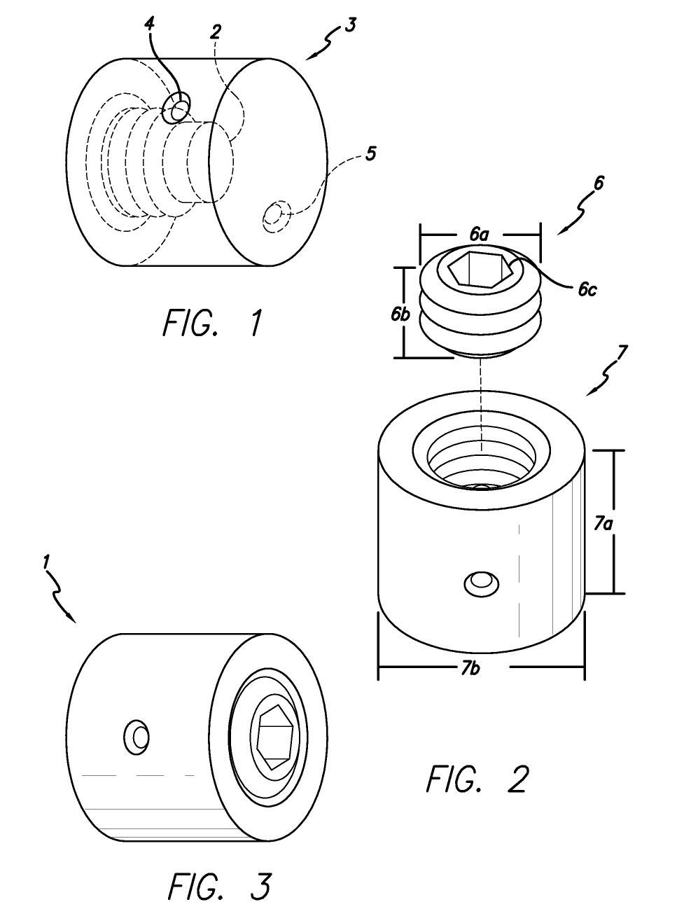

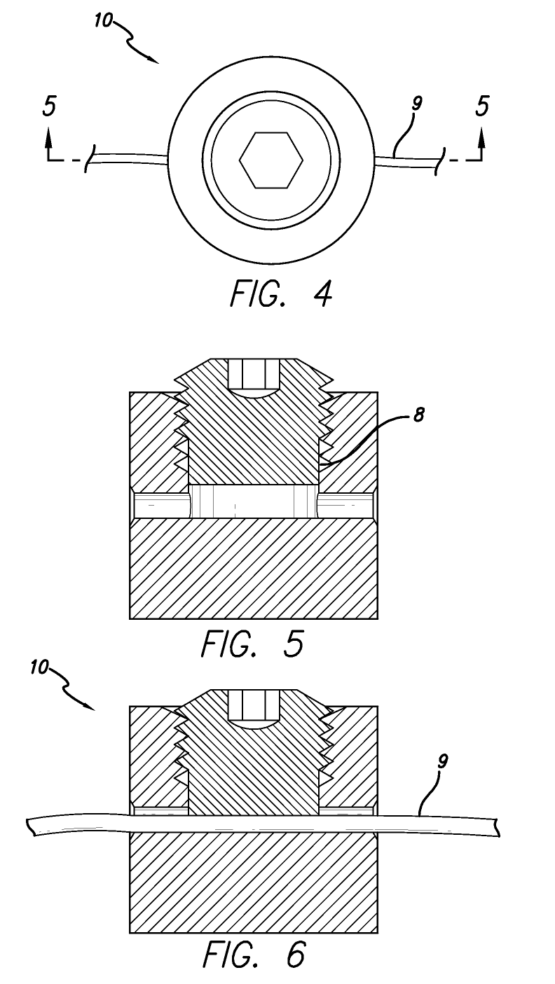

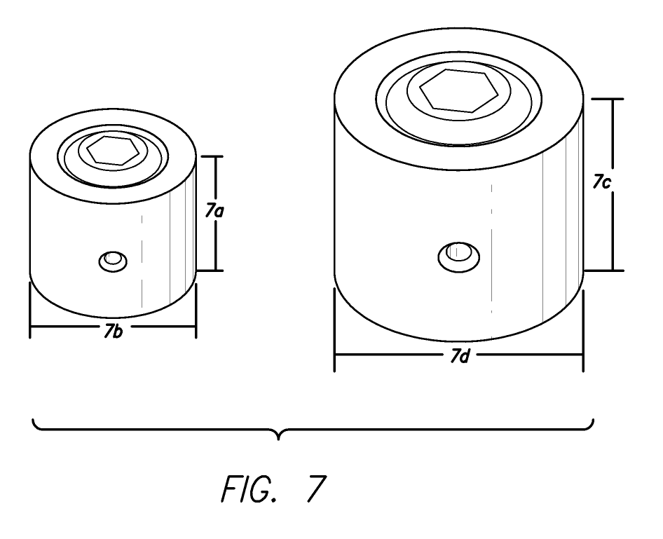

### FIELD OF THE INVENTION

This invention relates to a ball-ender apparatus, and more particularly to such an apparatus for securing to a pre selected length wire by passing through the apparatus and being secured by a precision screw from which the wire receives medial pressure locking the wire in place.

### BACKGROUND OF THE INVENTION

Wire musical instrument strings, as for electric bass guitars, guitars, etc., normally have one end terminated by a so-called ball end. Such a ball end normally is hollow, has a coaxial through-hole and has a substantially cylindrical outer peripheral surface with an annular groove intermediate its ends which snugly receives a loop of the wire closed by twisting of the wire immediately adjacent such loop and ball end. Such ball end thus forms an enlargement at the end of the wire string by which the latter can be fixed to a member on the body of the musical instrument and from which the wire extends to connect at its unballed end to a tuning key or the like at the head of the instrument.

In a prior machine for securing one end of a wire musical instrument string to a ball end with a twist, the wire is fed behind the ball end tangential to the groove therein, the ball end is moved rearwardly from the wire path to form a U-shape around the ball end, the trailing end of the wire is severed to form the short leg of the U-shape, the legs are clamped and the ball end is rotated to form such twist (hereinafter referred to as a single twist), whereafter the interconnected ball end and wire are ejected from the machine.

While such prior machine has for the most part been satisfactory in terms of formation of such a single twist, the present invention is the result of a continuing effort to achieve improved performance and reliability of operation of producing a ball-ended musical instrument string of desired length wherein the finished product may be provided without the use of expensive and cumbersome equipment.

Currently many types of music strings require a “ball end” to attach and secure the non-stretching part of the musical string to the musical instruments tail piece or bridge.

The ball ending process currently in use requires the wire to be looped around the slotted brass “ball-end” and then twisted around itself a number of times in order to tie the string wire around the brass ball end. This process requires an expensive ball ender machine to do this.

There is a limit to the diameter of wire that can be used to make a string using this ball ending process; usually a 0.008 is the smallest size for plain steel strings. When the string breaks, the ball end is discarded because it cannot be attached to another wire without the expensive ballending machine.

The other option currently used is a special bridge that must be attached to the instrument. A company called Floyed Rose has created a clamping bridge that allows a string wire to be clamped at the securing end of the string. This special bridge requires the removal of the original bridge. Once attached to the instrument, only plain wire may be used without a ball end attached.

The current device (clamping ball end) looks similar to the traditional ball end in shape and size. It is very different in that it has an entrance and exit hole for the wire. In the center of the clamping ball end housing is a threaded hole. The string enters the entrance hole and is pulled to the exit hole. Then, a special screw inserted into the threaded hole clamps the wire down. The LBF (pounds of force measured with a digital torque screwdriver) for the particular wire is set and the clamping screw is screwed in to just the right amount of force so that the string wire stays in place while under tension from tuning to high notes. This is done without an expensive winding machine. There is no winding of wire. No modifications need to be made to musical instruments.

The ball-end is its own clamp. This process enables the string to be used on any instrument that uses the traditional “twist the wire around the ball end” type string. Unlike the “twist type” ball end, the string can be easily replaced by removing the clamp screw and inserting a new piece of wire. The clamp screw is then re-attached, thus making a new string.

The clamp ball ends are made in a variety of sizes to work with all string wire gauges.

These clamping ball ends allow small gauges of wire such as 0.007, 0.006, 0.005, 0.004 and 0.003 to be used. These small gauges of wire break easily during the looping and twisting process using traditional ball ends and ball ending methods. The clamping ball end does not twist the wire and thus eliminates extra tension on the string.

A digital torque driver can be used to screw the clamp screw in and tighten it to a precise LBF (pounds of force) to clamp each type of wire with exactly the perfect amount of force to secure the string without breaking it. In addition, the larger clamping ball end sizes also allow a larger diameter hex core wire (used in making round wound strings) to be used because the wire does not have to bend around the ball end, thus making a bass string with a larger hex core wire possible. This vastly improves the quality of bass strings over 0.160 of an inch as the core wire is not too thin, and therefore does not flop.

Traditional twist ball ends are limited to a hex wire no larger than about 0.034 but the clamp ball end can be made to accept hex wire as large as 0.100, thus making a new type of bass string possible.

The clamp ends can also be made out of steel for securing heavier gauge, higher tensile wire that would other wise break when twisted around the traditional slotted twist ball end.

The number of threads in the clamp screw can change and the number of threads in the threaded hole in the housing can also change. The housing can also vary in size, shape etc. There is twist wire on slotted brass ball end, a clamping bridge which must be attached to the guitar, and then this concept, a string secured by a brass or steel, etc. clamp ball end.

### SUMMARY OF THE INVENTION

In accordance with the present invention, (clamping ball end) looks similar to the traditional ball end. It is very different in that it has an entrance and exit hole for the wire. In the center of the ball end is a threaded hole. The string enters the entrance hole and is pulled to the exit hole. Then, a special screw clamps the wire down. The LBF (pounds of force measured with a digital torque screwdriver) for the particular wire is set and the clamping screw is screwed in to just the right amount of force to hold the string wire in place while under tension from tuning to high notes. This is done without an expensive winding machine. There is no winding of wire. No modifications need to be made to musical instruments.

### BRIEF DESCRIPTION OF THE DRAWINGS

1) View of hex screw screwed into thread hole
2) Bottom view of set screw showing flat surface
3) View of set screw on its side and with flat surface bottom before set screw is
4) entrance hole for string wire into clamping ball end housing
5) Exit hole for end of guitar string at opposite end of “C”
6) Set screw
6a) set screw outer diameter
6b) Set screw length
6c) set screw hex head
7) Clamping ball end housing
7a) Bass guitar string clamping ball end housing height
7b) Bass Guitar string clamping ball end outer diameter
7c) Guitar string clamping ball end height
7d) Guitar string clamping ball end outer diameter
8) threaded hole for receiving “A” set screw
9) string wire
10) view of hex head set screw securing string wire in ball end housing thus making a functioning guitar string.

### DESCRIPTION OF THE PREFERRED EMBODIMENT

The clamping hex screw

The clamping ball end consists of two pieces.

The first piece is a precision threaded screw that can be a number of thread sizes. The size used for this description is a 4-80.

This screw (3) is used for both a guitar ball end and a bass guitar ball end. The screw size can vary depending on the instrument and type of string housing needed. For standard electric and steel string acoustic guitars and other similar instruments requiring a ball end to fit into a standardized bridge and tail piece, and for electric bass guitars, which require larger size housings, a standard set screw is used. Although the measurements can vary, the central outer diameter threaded section measurement is 0.110.

At the bottom of the threaded section is a smooth round section (2) and the bottom of the screw is flat. The smooth, flat section presses against the string wire (9) and secures the wire to the bottom of the inside area of the housing (7).

The length of the screw is 0.076. A hex wrench is used to tighten the screw at the hex head section (1). The amount of LBF-in. used to tighten the screw is measured to the desired amount. Set screws may also use a slot head, or any other type of screw heads (Phillips head, etc.), instead of a hex head screw.

The second piece of the clamping ball end is the clamping ball end housing (7). The clamping ball end housing is a cylinder shaped piece of metal made from brass, steel, or any other suitable materials capable of clamping and holding in place the end of a musical instrument string under tension. For standard guitars, this housing has a length that is 0.125 (7a), an outer diameter that is 0.150 (7b) and a threaded inner diameter that is 0.098. (8) This guitar string clamping ball end (7) has a string wire entrance hole (4) and exit hole (5) that is 0.017.

The Bass guitar clamping ball end (7c, 7d) housing has a length that is 0.185 (7c) and outer diameter that is 0.250 (7d) and a threaded inner diameter (8) that is 0.098. The clamping ball end (7c, 7d) has and entrance hole (4) and an exit hole (5) that is 0.034.

These housings (7) and the set screws (6), entrance holes (4) and exit holes (5) and threaded holes (8) can vary in measurements depending on the need to accommodate a particular stringed instrument such as an electric violin, pedal steel guitar or even a lute.

The string wire (9) is fed into the entrance hole (4) until it protrudes from the exit hole (5). A hex screw driver drives the hex set screw (6) by inserting the screwdriver blade into the hex head slot (6c) and the threaded area of the set screw (6b) turns into the threaded hole (8) on the clamping ball end housing (7) until the string wire (9) is secured by the desired pre-determined amount of force in LBF-in. needed for a particular gauge music string wire (9) to hold it in place securely. The finished string (10) is then ready to be put on the musical instrument.

Should the string break, the hex set screw (A) can be unscrewed and a broken string wire removed and then a replacement wire can be attached.

What is claimed is:

1. A clamping ball end for musical instruments for securing to a pre-selected length wire by passing through the apparatus and being secured by a precision screw from which the wire receives medial pressure locking the wire in place comprising;
a. set screw with hex head or any other type of screw heads
b. clamping ball end housing

2. A ball-ender apparatus as set forth in claim 1 wherein, the set screw or any other type of capable screw is manufactured in size from 0.050 to 0.200 (Length) and 0.100 to 0.185 (Diameter), or any other suitable size capable of securing the wire to the bottom of the inside area of the housing.

3. A ball-ender apparatus as set forth in claim 1 wherein, the ball end apparatus is manufactured for any stringed device.

4. A ball-ender apparatus as set forth in claim 1 wherein, the ball end apparatus is manufactured of metallic materials.

5. A ball-ender apparatus as set forth in claim 1 wherein the ball end apparatus is manufactured from resin based materials.

6. A ball-ender apparatus as set forth in claim 1 wherein the ball end apparatus is manufactured of any suitable materials capable of clamping and holding in place, the end of a musical instrument string under tension.

7. A ball-ender apparatus as set forth in claim 1 wherein the ball end apparatus is manufactured in metric sizing and inches.

8. A ball-ender apparatus as set forth in claim 1 wherein the ball end apparatus is manufactured with more than one hole by which to pass string through.
